(19) United States
(12) Patent Application Publication
(10) Pub. No.: US 2018/0347134 A1
(43) Pub. Date: Dec. 6, 2018

(54) Filtering Occupation Containment Utilization System

(71) Applicants: Kenneth Stefan Jones, Falls Church, VA (US); Devon Morris, Dallas, TX (US)

(72) Inventors: Kenneth Stefan Jones, Falls Church, VA (US); Devon Morris, Dallas, TX (US)

(21) Appl. No.: 15/994,953

(22) Filed: May 31, 2018

Related U.S. Application Data
(60) Provisional application No. 62/512,810, filed on May 31, 2017.

(51) Int. Cl. E02B 15/04; E02B 15/06; B01D 17/02; B01D 29/50; B01D 35/05; C02F 1/00; C02F 1/40

(52) U.S. Cl. CPC E02B 15/045; E02B 15/06; B01D 17/02; C02F 2101/32; B01D 35/05; C02F 1/004; C02F 1/40; B01D 29/50

(57) ABSTRACT

A containment system consists of a set of filtering units, a first float, a second float, and a sliding mechanism. The set of filtering units is used to filter an oil spill or other hazardous material. The first float and the second float allow the apparatus to stay afloat in the water source. The sliding mechanism allows the user to control the first float and the second float and thus, control the submersion level of the set of filtering units. Each of the set of filtering units is interconnected through a first interlocking mechanism and a second interlocking mechanism. A plurality of perforated filter cartridges of the set of filtering units executes the filtering process. Preferably, the plurality of perforated filter cartridges will be removably positioned within an enclosure.

The current application claims a priority to the U.S. Provisional Patent application Ser. No. 62/512,810 filed on May 31, 2017.

### FIELD OF THE INVENTION

The present invention relates generally to an apparatus that is suspended in fluid to contain hazardous material such as oil spills. In doing so, the present invention creates a floating barrier to impede the advance and spread of the hazardous material.

### BACKGROUND OF THE INVENTION

The recent surge in oil production due to the increasing demand has forced oil manufacturers to expedite the distribution process. Simultaneously, the number of oil spills has also increased in the recent past leading to devastating results. The immediate need to address the issue is evident through the destruction caused by the oil spills.

Booms, dispersants, and biological agents are generally used when attempting to contain an oil spill or other hazardous material. Even though these methods have specific advantages they present certain drawbacks too. As an example, most booms cannot be used in high seas and under conditions with high winds. With the use of dispersants and biological agents, the oil spill may be contained but the marine life in the vicinity can be destroyed. Allowing the oil to break down naturally is another method currently in use. Even though this method is effective for relatively small oil spills, using this method for large oil spills can be costly. The marine life surrounding the area can be heavily damaged due to the lengthy process.

The objective of the present invention is to address the aforementioned issues. In particular, the present invention introduces a system that can contain and confine chemical disasters at the point of contact. In doing so the present invention utilizes a lightweight, environmentally safe device that requires minimal maintenance. The effective design of the present invention allows the present invention to adjust according to the roughness of the water. Since, the present invention is made of environmentally friendly material, the marine life is not harmed in the process of containing an oil spill. Additionally, the reduction in labor costs and material costs is financially advantageous to the user.

### BRIEF DESCRIPTION OF THE DRAWINGS

FIG. 1A is a perspective view of the present invention, wherein the set of filtering units is illustrated.

FIG. 1B is a perspective view of a selected filtering unit from the set of filtering units.

FIG. 2 is a front view of the selected filtering unit.

FIG. 3 is a rear view of the selected filtering unit.

FIG. 4 is a perspective exploded view of the selected filtering unit.

FIG. 5 is another perspective exploded view of the selected filtering unit.

FIG. 6 is a perspective view of the enclosure.

FIG. 7 is a perspective view of a selected filter cartridge from the plurality of perforated filter cartridges.

FIG. 8A is a side view of the selected filtering unit, wherein the vertical sliding mechanism is illustrated.

FIG. 8B is another side view of the selected filtering unit, wherein the vertical sliding mechanism is illustrated.

FIG. 9 is a perspective view of the set of filtering units in another embodiment, wherein the horizontal sliding mechanism is illustrated.

### DETAIL DESCRIPTIONS OF THE INVENTION

All illustrations of the drawings are for the purpose of describing selected versions of the present invention and are not intended to limit the scope of the present invention.

The present invention is an apparatus that is used to contain oil spills or other hazardous material at the point of contact. In doing so, the present invention creates a barrier system by interconnecting a set of individual filtering units. The interconnection between each of the filtering units allows the filtering units to adjust according to the roughness of water source the present invention is used in.

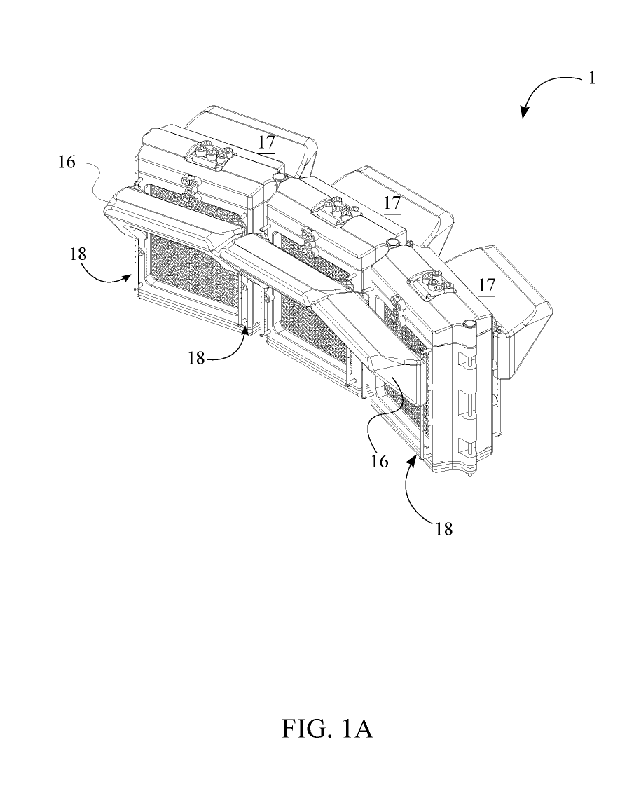

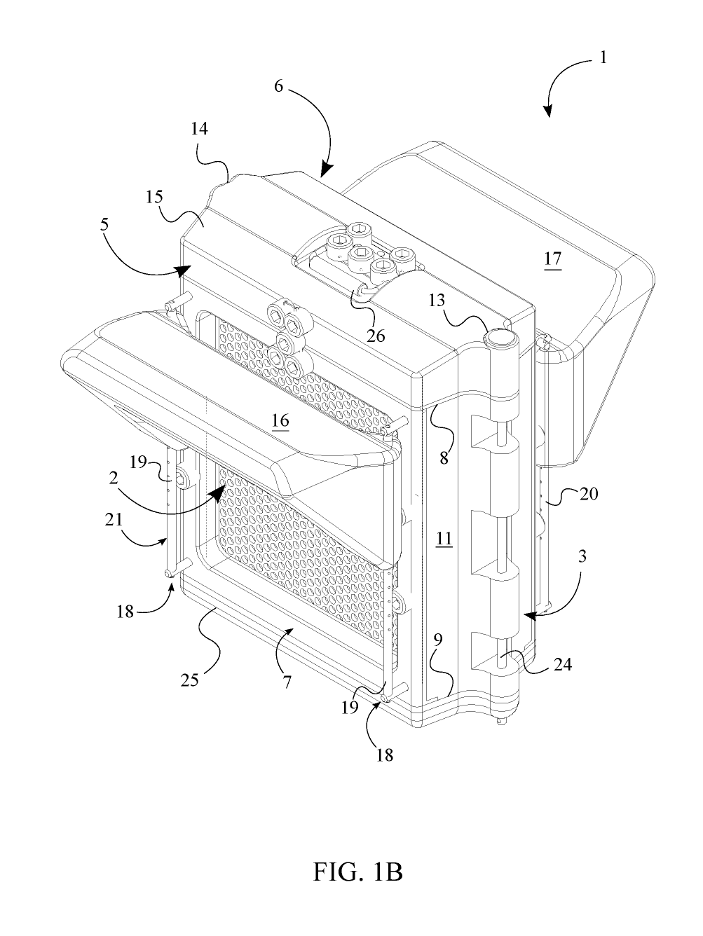

As seen in FIG. 1A, to fulfill the intended functionalities, the present invention comprises a set of filtering units 1, a first float 16, a second float 17, and a sliding mechanism 18. The first float 16 and the second float 17 are used to keep the set of filtering units 1 afloat. To form a barrier around the oil spill or other hazardous substance, each of the set of filtering units 1 is interconnected to each other. The submersion levels of the set of filtering units 1 is controlled by adjusting the first float 16 and the second float 17 through the sliding mechanism 18.

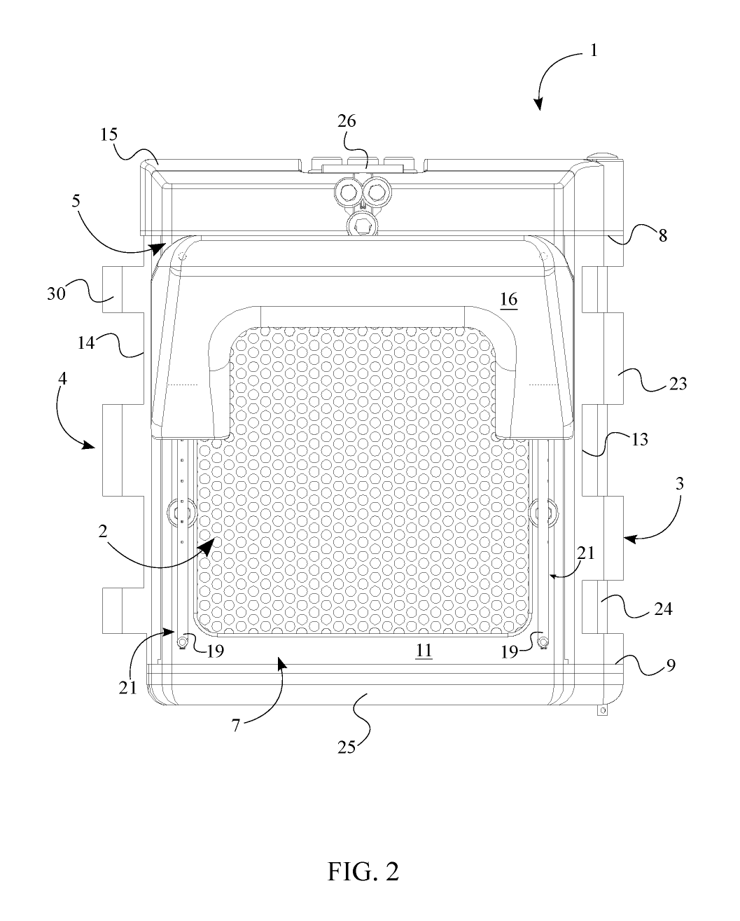

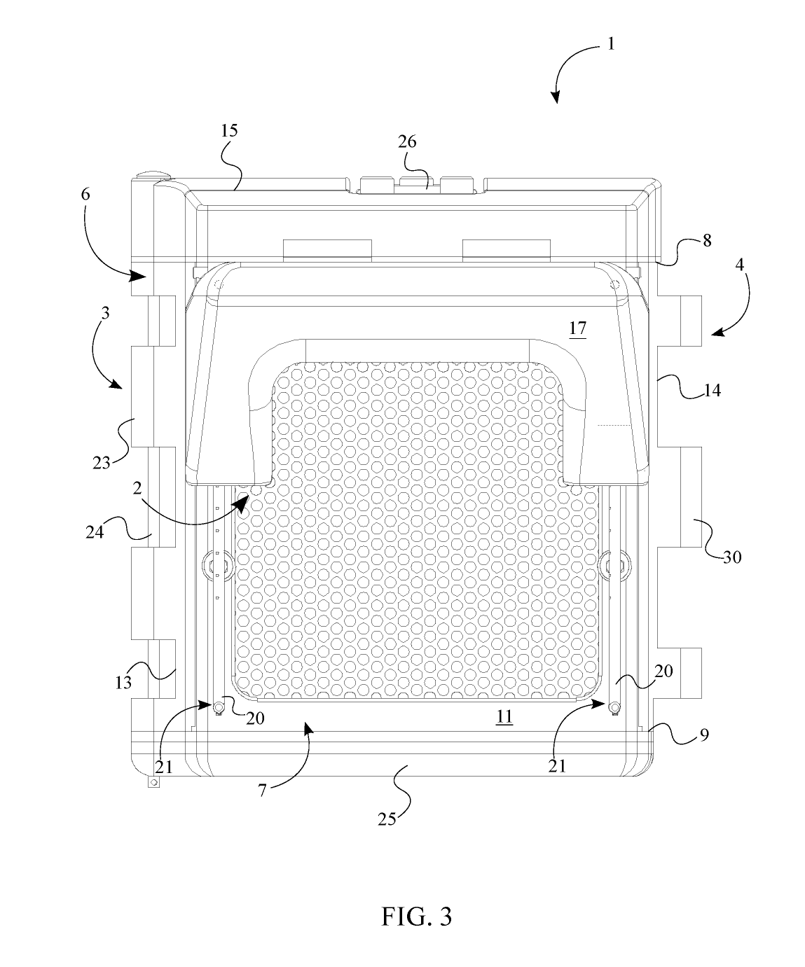

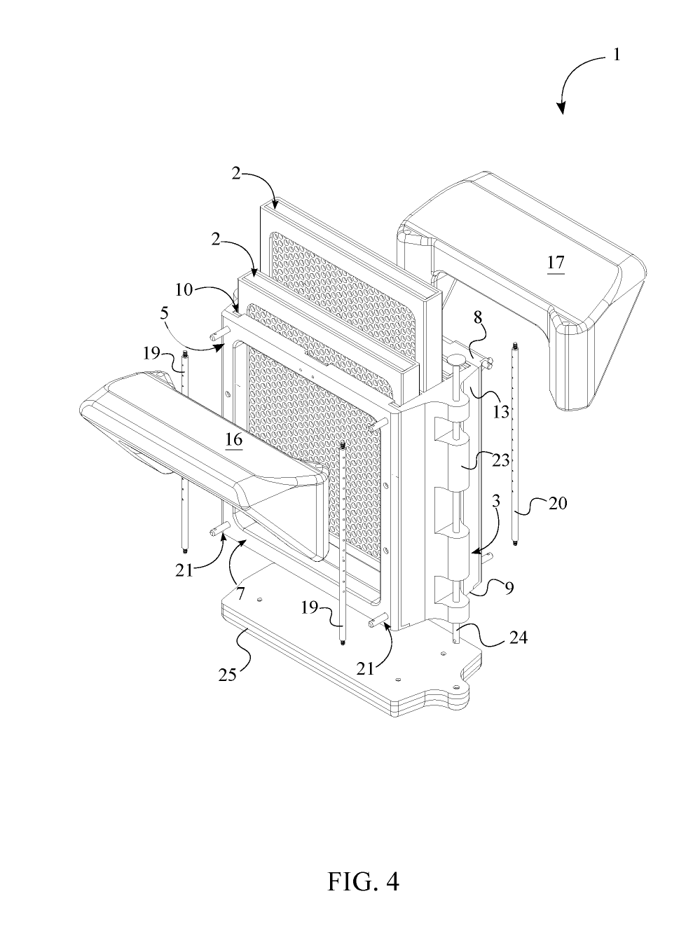

As illustrated in FIG. 1B, FIG. 2, and FIG. 3, to execute the filtering process, each of the set of filtering units 1 comprises a plurality of perforated filter cartridges 2, a first interlocking mechanism 3, and a second interlocking mechanism 4. The shape and size of each of the plurality of perforated filter cartridges 2 can vary from one embodiment to another. As seen in FIG. 4, to optimize the filtering process, each of the plurality of perforated filter cartridges 2 is layered adjacent to each other within a body of one of the set of filtering units 1. The perforations of each of the plurality of perforated filter cartridges 2 allows water to flow through the set of filtering units 1, eliminating pressure build up within each of the set of filtering units 1.

The first interlocking mechanism 3 and the second interlocking mechanism 4 are used to interlock each of the set of filtering units 1 to form a boom around the oil spill or other area of concern. To do so, the first interlocking mechanism 3 is laterally connected to each of the set of filtering units 1. To interlock with a subsequent unit from the set of filtering units 1, the second interlocking mechanism 4 is laterally connected to each of the set of filtering units 1 opposite the first interlocking mechanism 3. More specifically, the set of filtering units 1 is interlocked to each other through the first interlocking mechanism 3 and the second interlocking mechanism 4.

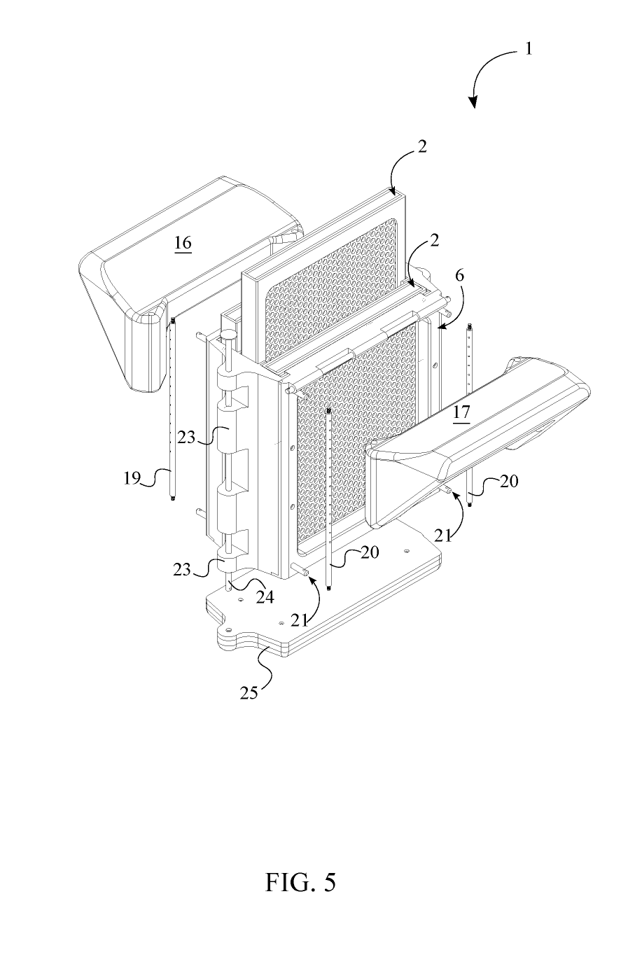

The first float 16 and the second float 17 which are shown in FIG. 4 and FIG. 5, are used to partially or completely submerge the set of filtering units 1. The shape and size of the first float 16 and the second float 17 can vary from one embodiment to another. The first float 16 is positioned against an anterior surface 5 of each of the filtering units 1. In the preferred embodiment, the first float 16 is oriented horizontally. To correspond with the first float 16, the second float 17 is positioned against a posterior surface 6 of each of the set of filtering units 1 and positioned opposite the first float 16. In the preferred embodiment, the second float 17 is also oriented horizontally. The position of both the first float 16 and the second float 17 is controlled through the sliding mechanism 18.

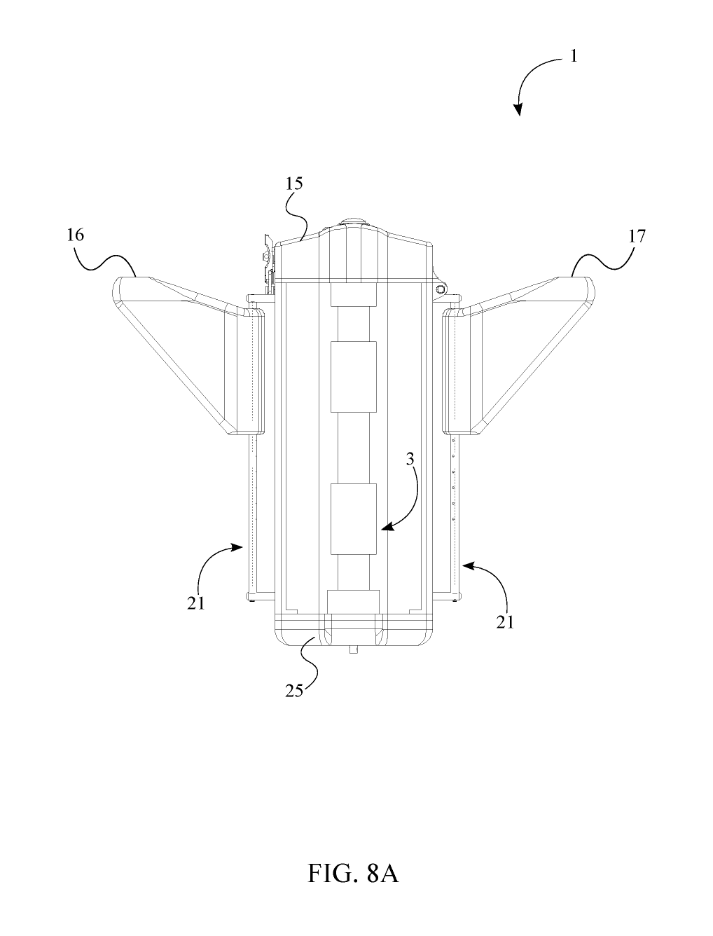

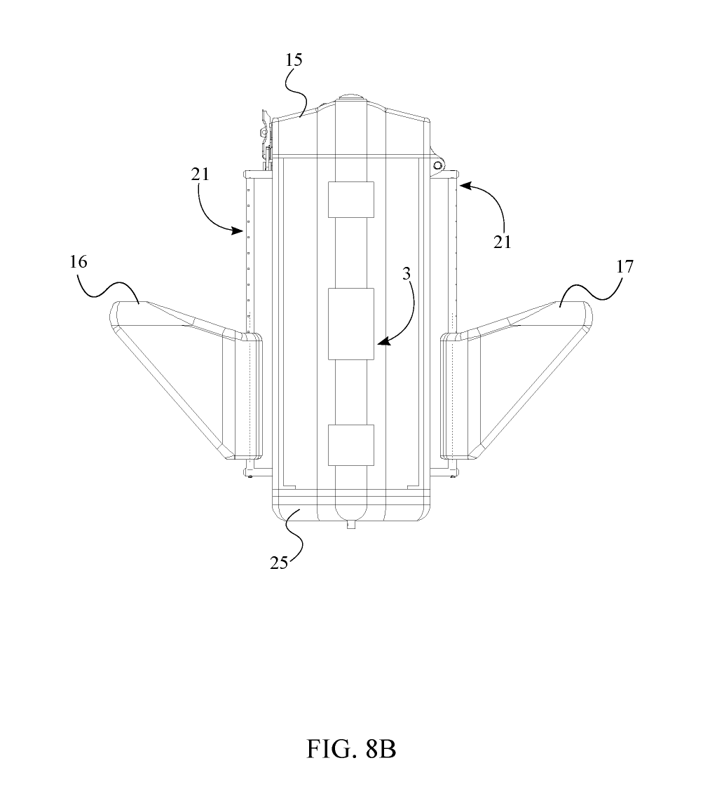

The sliding mechanism 18 can be a vertical sliding mechanism 21 or a horizontal sliding mechanism 22, wherein the vertical direction is defined from a top end 8 to a bottom end 9. On the other hand, the horizontal direction is defined from a first lateral end 13 to a second lateral end 14. As illustrated in FIG. 8A and FIG. 8B, when the first float 16 and the second float 17 are intended to move in a vertical direction, the sliding mechanism 18 comprises a pair of front rails 19 and a pair of rear rails 20. The pair of front rails 19 vertically extend along the anterior surface 5. On the other hand, the pair of rear rails 20 vertically extend along the posterior surface 6. To enable vertical movement, the first float 16 is slidably engaged along the pair of front rails 19. Likewise, the second float 17 is slidably engaged along the pair of rear rails 20. By adjusting the first float 16 and the second float 17 through the vertical sliding mechanism 21, the overall filtering area in contact with water can be adjusted. For instance, when the first float 16 and the second float 17 are positioned as shown in FIG. 8A, an optimal surface area is exposed for filtering purposes. On the other hand, when the first float 16 and the second float 17 are positioned as shown in FIG. 8B a minimal surface area is exposed for filtering purposes.

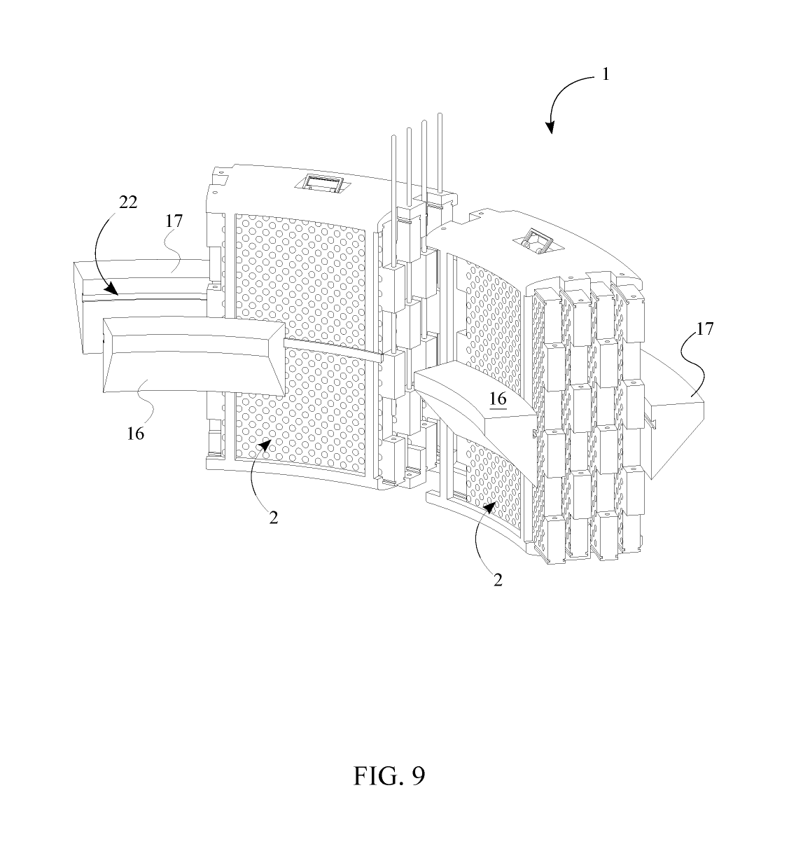

In another embodiment, when the first float 16 and the second float 17 are intended to move in a horizontal direction in another embodiment, the sliding mechanism 18 is a horizontal sliding mechanism 22, as seen in FIG. 9. To execute the horizontal movement, the sliding mechanism 18 comprises a pair of front rails 19 and a pair of rear rails 20. The pair of front rails 19 will horizontally extend along the anterior surface 5. On the other hand, the pair of rear rails 20 will horizontally extend along the posterior surface 6. To enable horizontal movement, the first float 16 is slidably engaged with the pair of front rails 19. Moreover, the second float 17 is slidably engaged along the pair of rear rails 20.

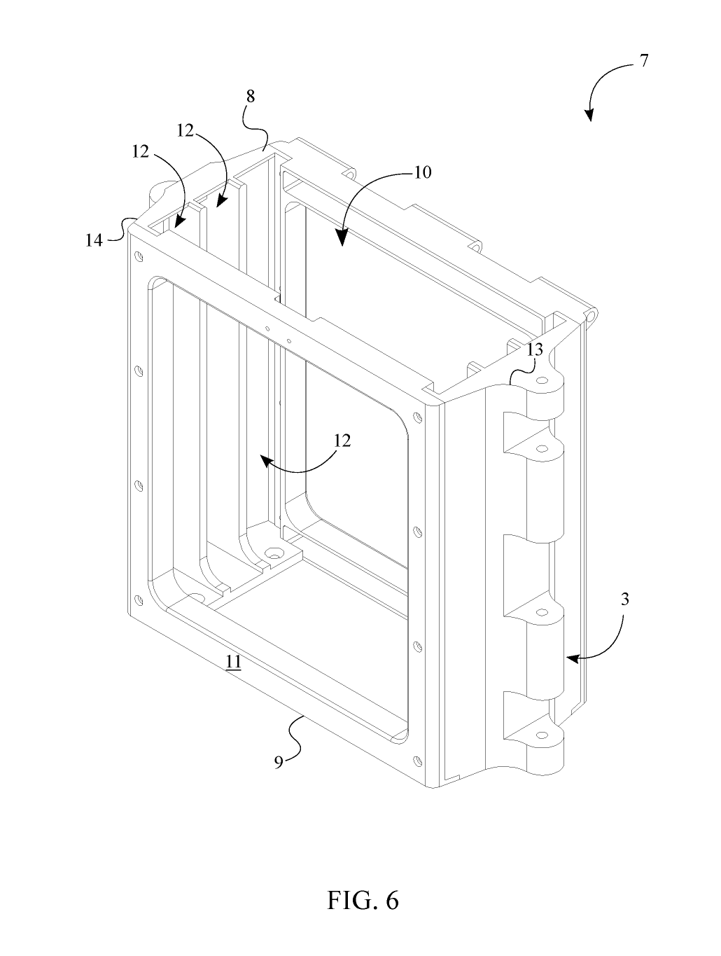

As shown in FIG. 6, in the preferred embodiment of the present invention, each of the set of filtering units 1 further comprises an enclosure 7, wherein the enclosure 7 comprises a top end 8, a hollow body 11, a bottom end 9, an opening 10, a plurality of cartridge receiving slots 12, a first lateral end 13, and a second lateral end 14. The hollow body 11 extends from the top end 8 to the bottom end 9 and determines an overall height of the hollow body 11. The overall size and shape of the hollow body 11 can vary in different embodiments. Each of the plurality of perforated filter cartridges 2 is removably positioned into one of the plurality of cartridge receiving slots 12. To be positioned within the hollow body 11, each of the plurality of cartridge receiving slots 12 extends from the top end 8 to the bottom end 9. During the process of inserting, the plurality of perforated filter cartridges 2 is inserted through the opening 10 which traverses through the top end 8. Since the plurality of perforated filter cartridges 2 is removably positioned, a specific filter cartridge from the plurality of perforated filter cartridges 2 can be replaced without impacting the overall configuration of the set of filtering units 1. To fulfill the interlocking purposes, the first interlocking mechanism 3 is positioned along the first lateral end 13. In contrast, the second interlocking mechanism 4 is positioned along the second lateral end 14.

As seen in FIG. 2 and FIG. 3, to conceal the plurality of perforated filter cartridges 2, the enclosure 7 further comprises a lid 15 that is pivotally connected to the hollow body 11 at the top end 8. When a specific perforated filter cartridge needs to be replaced, the lid 15 is controlled to access the opening 10. The opening 10 can be sealed by using a latch in conjunction with the lid 15. To provide convenience in handling, the present invention further comprises a handle 26. Preferably, the handle 26 is centrally connected to the lid 15 opposite the hollow body 11.

As mentioned earlier, the first float 16 and the second float 17 are used to submerge a preferred height of the set of filtering units 1. However, to maintain the set of filtering units 1 in an upright position for optimal filtering purposes, the present invention further comprises a counterweight 25. As shown in FIG. 4 and FIG. 5, preferably, the counterweight 25 is terminally connected to the hollow body 11 at the bottom end 9.

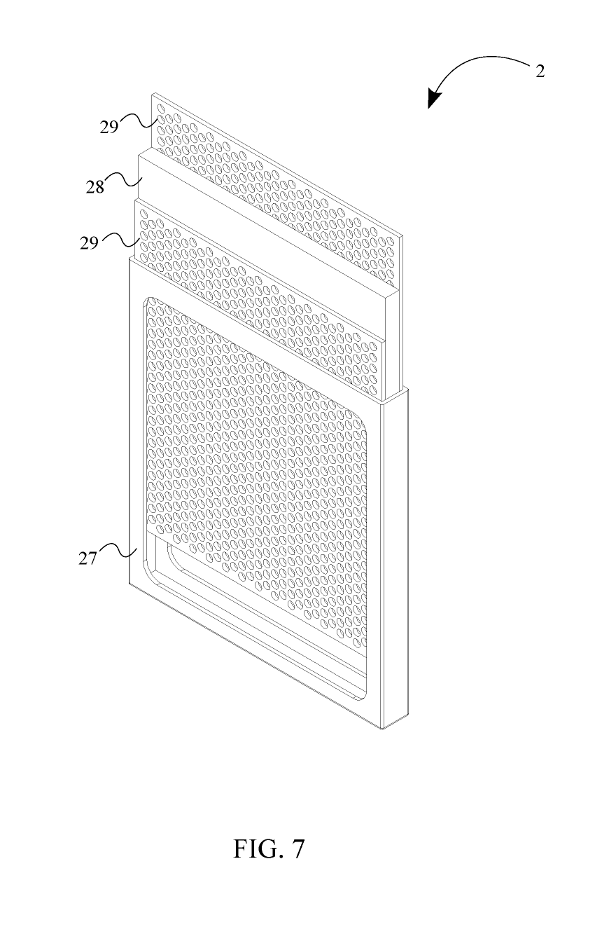

The plurality of perforated filter cartridges 2 can vary from one embodiment to another. As seen in FIG. 7, in the preferred embodiment, each of the plurality of perforated filter cartridges 2 comprises a cartridge frame 27, a filter material 28, and a pair of perforated sheets 29. The assembly of the filter material 28 and the pair of perforated sheets 29 is perimetrically sleeved by the cartridge frame 27. The filter material 28 is positioned in between the pair of perforated sheets 29. Thus, the plurality of perforated filter cartridges 2 can be conveniently positioned into the plurality of cartridge receiving slots 12.

The first interlocking mechanism 3 and the second interlocking mechanism 4 can vary in different embodiments of the present invention. As further illustrated in FIG. 2 and FIG. 3, in the preferred embodiment of the present invention, the first interlocking mechanism 3 comprises a first set of hinges 23 and an interlocking rod 24. On the other hand, the second interlocking mechanism 4 comprises a second set of hinges 30. When a selected filtering unit from the set of filtering units 1 is to be attached to a subsequent filtering unit from the set of filtering units 1, the first set of hinges 23 is concentrically aligned with the second set of hinges 30. When positioned as required, the interlocking rod 24 is positioned through the first set of hinges 23 and the second set of hinges 30 so that the selected filtering unit is attached to the subsequent filtering unit.

When the present invention is in use, the following process flow is generally followed. The plurality of perforated filter cartridges 2 is initially positioned into the plurality of cartridge receiving slots 12 to construct the set of filtering units 1. Next, each of the set of filtering units 1 is interconnected to each other through the first interlocking mechanism 3 and the second interlocking mechanism 4. Subsequently, the set of filtering units 1 is positioned in an area of concern. The set of filtering units 1 remain in an upright position with the use of the counterweight 25. If the need occurs to replace a selected filter cartridge from the plurality of perforated filter cartridges 2, the user opens the lid 15 and replaces the selected filter cartridge. Thus, the overall configuration of the set of filtering units 1 remains unchanged.

Although the invention has been explained in relation to its preferred embodiment, it is to be understood that many other possible modifications and variations can be made without departing from the spirit and scope of the invention as hereinafter claimed.

What is claimed is:

1. A filtering occupation containment utilization system comprises:
a set of filtering units;
a first float;
a second float;
a sliding mechanism;
each of the set of filtering units comprises a first interlocking mechanism, a second interlocking mechanism, and a plurality of perforated filter cartridges;
each of the plurality of perforated filter cartridges being layered adjacent to each other within a body of one of the set of filtering units;
the first interlocking mechanism being laterally connected to each of the set of filtering units;
the second interlocking mechanism being laterally connected to each of the set of filtering units opposite the first interlocking mechanism;
the first float being oriented horizontally and positioned against an anterior surface of each of the set of floating units through the sliding mechanism;
the second float being oriented horizontally and positioned against a posterior surface each of the set of floating units through the sliding mechanism, wherein the second float is positioned opposite the first float; and
each of the set of filtering units being removably attached to each other through the first interlocking mechanism and the second interlocking mechanism.

2. The filtering occupation containment utilization system as claimed in claim 1, wherein the first float is being oriented horizontally.

3. The filtering occupation containment utilization system as claimed in claim 1, wherein the second float is oriented horizontally.

4. The filtering occupation containment utilization system as claimed in claim 1 further comprises:
each of the set of filtering units further comprises an enclosure;
the enclosure comprises a top end, a hollow body, a bottom end, an opening, a plurality of cartridge receiving slots, a first lateral end, and a second lateral end;
each of the plurality of perforated filter cartridges being removably positioned into one of the plurality of cartridge receiving slots;
each of the plurality of cartridge receiving slots extending from the top end to the bottom end;
the first interlocking mechanism being positioned along the first lateral end;
the second interlocking mechanism being positioned along the second lateral end;
the hollow body extending from the top end to the bottom end; and
the opening traversing through the top end.

5. The filtering occupation containment utilization system as claimed in claim 4 further comprises:
the enclosure further comprises a lid; and
the lid being pivotally connected to the hollow body at the top end.

6. The filtering occupation containment utilization system as claimed in claim 5 further comprises:
a handle; and
the handle being centrally connected to the lid opposite the hollow body.

7. The filtering occupation containment utilization system as claimed in claim 4 further comprises:
a counterweight; and
the counterweight being terminally connected to the hollow body at the bottom end.

8. The filtering occupation containment utilization system as claimed in claim 1 further comprises:
each of the plurality of perforated filter cartridges comprises a cartridge frame, a filter material, and a pair of perforated sheets;
the filter material and the pair of perforated sheets being perimetrically sleeved by the cartridge frame; and
the filter material being positioned in between the pair of perforated sheets.

9. The filtering occupation containment utilization system as claimed in claim 1 further comprises:
wherein the sliding mechanism is a vertical sliding mechanism, wherein a vertical direction is defined from a top end to a bottom end of an enclosure;
the sliding mechanism comprises a pair of front rails and a pair of rear rails;
the pair of front rails vertically extending along the anterior surface;
the pair of rear rails vertically extending along the posterior surface;
the first float being slidably engaged along the pair of front rails; and
the second float being slidably engaged along the pair of rear rails.

10. The filtering occupation containment utilization system as claimed in claim 1 further comprises:
wherein the sliding mechanism is a horizontal sliding mechanism, wherein a horizontal direction defined from a first lateral end to a second lateral end of an enclosure;
the sliding mechanism comprises a pair of front rails and a pair of rear rails;
the pair of front rails horizontally extending along the anterior surface;
the pair of rear rails horizontally extending along the posterior surface;
the first float being slidably engaged along the pair of front rails; and
the second float being slidably engaged along the pair of rear rails.

11. The filtering occupation containment utilization system as claimed in claim 1 further comprises:
the first interlocking mechanism comprises a first set of hinges and an interlocking rod;
the second interlocking mechanism comprises a second set of hinges;
the first set of hinges being concentrically aligned with the second set of hinges; and
the interlocking rod being positioned through the first set of hinges and the second set of hinges.
